(19) United States
(12) Patent Application Publication
(10) Pub. No.: US 2015/0086828 A1
(43) Pub. Date: Mar. 26, 2015

(54) BATTERY POWER SYSTEM

(71) Applicant: UER TECHNOLOGY CORPORATION, Miaoli County (TW)

(72) Inventors: RAY-TANG SUN, Miaoli (TW); TSUNG-HSIEN CHUANG, Miaoli (TW); NIEN-TIEN CHENG, Miaoli (TW); CHIEN-LUNG CHEN, Miaoli (TW)

(73) Assignee: UER TECHNOLOGY CORPORATION, Miaoli County (TW)

(21) Appl. No.: 14/067,980

(22) Filed: Oct. 31, 2013

(30) Foreign Application Priority Data
Sep. 25, 2013 (TW) 102134512

(51) Int. Cl. H01M 10/6552

(52) U.S. Cl. CPC H01M 10/5048
USPC 429/120

(57) ABSTRACT

A battery power system includes two battery modules stacked together and a heat dissipating unit. Each battery module includes a heat conductive sheet positioned at a side facing toward the other battery module. The heat dissipating unit includes heat pipes positioned between the battery modules and in contact with the heat conductive sheet of each battery module.

### BACKGROUND

1. Technical Field

The present disclosure relates to battery power systems, and particularly to a battery power system comprised of a number of battery modules.

2. Description of Related Art

Battery power systems, especially for battery power systems used in vehicles, include a number of battery modules, each of which includes a number of battery cells. In use, the battery power system generates a lot of heat. If the heat can not be efficiently and timely dissipated, a quality, stability, and security of the battery power system may be degraded. At present, a heat dissipating structure of the battery power system is complicated and has a low heat dissipating efficiency.

Therefore, what is needed is a battery power system addressing the limitations described.

### BRIEF DESCRIPTION OF THE DRAWING

The components of the drawing are not necessarily drawn to scale, the emphasis instead being placed upon clearly illustrating the principles of the embodiments of the present disclosure.

FIG. 1 is an isometric view of a battery power system, according to an exemplary embodiment of the present disclosure.

FIG. 2 is an exploded view of the battery power system of FIG. 1.

### DETAILED DESCRIPTION

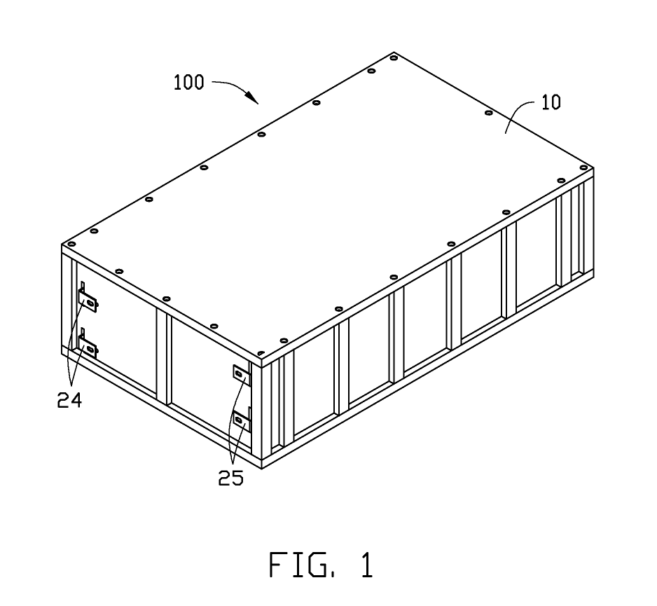

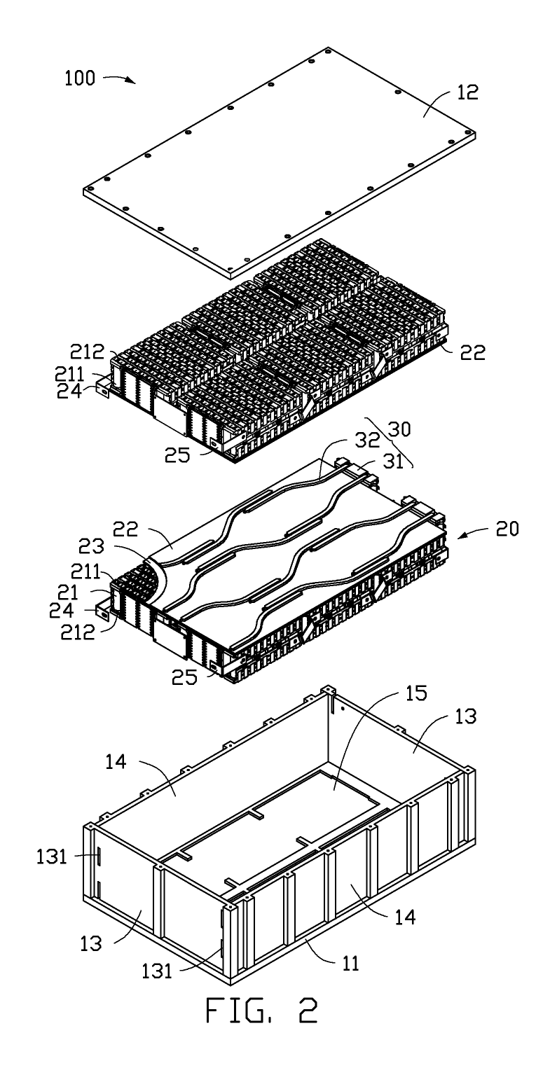

FIGS. 1 and 2 show a battery power system 100 of an exemplary embodiment of the present disclosure. The battery power system 100 includes a housing 10, a number of battery modules 20 received in the housing 10, and a number of heat dissipating units 30 received in the housing 10.

The housing 10 is substantially rectangular-shaped. The housing 11 includes a bottom plate 11, a top plate 12, two opposite first side plates 13, and two opposite second side plates 14. The bottom plate 11 and the top plate 12 are substantially parallel to each other. The first side plates 13 and the second side plates 14 are connected between the bottom plate 11 and the top plate 12. The first side plates 13 are substantially parallel to each other, the second side plates 14 are substantially parallel to each other, and the first side plates 13 are perpendicularly connected the second side plates 14. The bottom plate 11, the top plate 12, the first side plates 13, and the second side plates 14 cooperatively define a receiving space 15. One of the first side plates 13 defines a number of through holes 131 communicating with the receiving space 15.

The battery modules 20 are stacked and received in the receiving space 15. In this embodiment, the number of the battery modules 20 is two. Alternatively, the number of the battery modules 20 can be changed according to needs, and a size of the housing 10 can be accordingly changed. Each battery module 20 includes a number of battery cells 21 and a heat conductive sheet 22 positioned at a side of the cells 21, in this embodiment, the cells 21 are arranged in a matrix. The cells 21 are substantially cylindrical-shaped. Each cell 21 includes a positive end 211 and an opposite negative end 212. In this embodiment, the cell 21 is a lithium battery or other suitable rechargeable batteries. The heat conductive sheet 22 is positioned at the positive end of each cell 21. The heat conductive sheet 22 is made from a material(s) with high heat conductivity, such as copper and aluminum. The battery module 20 further includes an electrically insulative and heat conductive adhesive layer 23. The heat conductive sheet 22 is fixed to the positive end of each cell 21 by the adhesive layer 23. In this embodiment, the adhesive layer 23 is made from heat conductive silica gel. The adhesive layer 23 can conduct heat from the cells to the heat conductive sheet 22 and electrically insulate the cells 21 from the heat conductive sheet 22.

Each battery module 20 includes a positive terminal 24 and a negative terminal 25. The positive terminal 24 is electrically connected to the positive ends 211 of the cells 21, and the negative terminal 25 is electrically connected to the negative ends 212 of the cells 21. The positive terminal 24 and negative terminal 25 extend out of the housing 10 through the through holes 131.

The battery modules 20 are stacked in such a manner that the positive ends thereof face each other. Therefore, a space between the heat conductive sheets 22 forms a heat dissipating channel.

Each heat dissipating unit 30 includes a heat exchanging member 31 and a number of heat pipes 32 connected to the heat exchanging member 31. The heat exchanging member 31 contains a cooling liquid (not shown) therein. The heat exchanging member 31 can infuse the cooling liquid into the heat pipes 32 and recycle the cooling liquid from the heat pipes 32, thus heat can be carried by flowing cooling liquid between the heat exchanging member 31 and the heat pipes 32. The cooling liquid can circularly flow between the heat exchanging member 31 and the heat pipes 32 by a pump (not shown) positioned in the exchanging member 31 or capillary structures (not shown) formed in the heat pipes 32.

The exchanging member 31 is positioned at a side of the stack of the battery modules 20 away from a side with the positive terminals 24 and the negative terminals 25 and is fixed on the first side plate 13 away from the positive terminals 24 and the negative terminals 25. The heat pipes 32 are positioned between the battery modules 20 and are in contact with the heat conductive sheets 22. The heat pipes 32 extend along a curve path in the space between the battery modules 20 for evenly dissipating heat from the battery modules 32.

In this embodiment, the heat conductive sheet 22 and the adhesive 23 are positioned at the positive end of each cell 21. It is understood that a similar heat conductive sheet and adhesive layer can be formed at the negative end of each cell 21. In the situation that both of the positive side and negative side of the battery module 20 have the heat conductive sheet 22, the heat pipes 32 can extend to the negative ends of the cells 21. The battery modules 20 can be stack with the negative end of each cell of one battery module 20 opposite to the positive end of each cell of the other battery module 20, or the negative sides opposite to each other.

In this embodiment, the number of the battery modules 20 is two, it is understood that the number of the battery modules 20 can be changed according to different requirement.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the disclosure.

What is claimed is:

1. A battery power system, comprising:
two battery modules stacked together, each battery module comprising a heat conductive sheet positioned at a side facing toward the other battery module; and
a heat dissipating unit comprising a plurality of heat pipes positioned between the battery modules and in contact with the heat conductive sheet of each battery module.

2. The battery power system of claim 1, wherein each battery module comprises a plurality of cells arranged in a matrix, each cell comprises a positive end and an opposite negative end.

3. The battery power system of claim 2, wherein the heat conductive sheet is positioned at the positive end of each cell.

4. The battery power system of claim 3, wherein each battery module comprises an electric insulative and heat conductive adhesive layer, the heat conductive sheet is fixed to the positive end of each cell by the adhesive layer.

5. The battery power system of claim 4, wherein the adhesive layer is made from heat conductive silica gel.

6. The battery power system of claim 2, wherein the battery power system comprises a housing, the housing defines a receiving space, the battery modules and the heat dissipating unit are received in the receiving space.

7. The battery power system of claim 6, wherein the housing comprises a bottom plate, a top plate opposite to the bottom plate, two opposite first side plates, and two opposite second side plates, the receiving space is defined between the bottom plate, the top plate, the first side plates, and the second side plates.

8. The battery power system of claim 7, wherein each battery module comprises a positive terminal and a negative terminal, the positive terminal is electrically connected to the positive ends of the cells, and the negative terminal is electrically connected to the negative ends of the cells.

9. The battery power system of claim 8, wherein one of the first side plates defines a plurality of through holes communicating with the receiving space, the positive terminal and the negative terminal extend out of the housing through the through holes.

10. The battery power system of claim 1, wherein the heat pipes extend along a curve path in the space between the battery modules.

11. The battery power system of claim 1, wherein the heat dissipating unit comprises a heat exchanging member connected to the heat pipes, the heat exchanging member contains a cooling liquid therein, the heat exchanging member infuses the cooling liquid into the heat pipes and recycles the cooling liquid from the heat pipes.

12. The battery power system of claim 11, wherein the exchanging member is positioned at a side of the battery modules.
